(19) United States
(12) Patent Application Publication
(10) Pub. No.: US 2006/0109382 A1
(43) Pub. Date: May 25, 2006

(54) Display apparatus and control method thereof

(75) Inventor: Jung-bae Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/273,406

(22) Filed: Nov. 15, 2005

(30) Foreign Application Priority Data
Nov. 25, 2004 (KR) 10-2004-0097686

(51) Int. Cl. H04N 9/74

(52) U.S. Cl. 348/584

(57) ABSTRACT

A display apparatus and control method thereof. The display apparatus includes a first processor outputting a on-screen display (OSD) video signal or a processed first video signal including an OSD window; an OSD extractor extracting the OSD window from the OSD video signal; and a second processor mixing an externally inputted second video signal and the OSD window extracted from the OSD extractor, and outputting the mixed signal. A display apparatus is thus provided which generates a uniform OSD window and reduces costs.

### CROSS-REFERENCE TO RELATED APPLICATIONS

This application claims priority from Korean Patent Application No. 10-2004-0097686, filed on Nov. 25, 2004 in the Korean Intellectual Property Office, the disclosure of which is incorporated herein by reference.

### BACKGROUND OF THE INVENTION

1. Field of the Invention

The present invention relates to a display apparatus and a control method thereof, and more particularly, to a display apparatus and a control method thereof in which a process of generating an on-screen display (OSD) is improved.

2. Description of the Related Art

Generally, a display apparatus receives a video signal from a video signal source such as a video card, a TV card of a computer, etc., thereby displaying a picture on a screen thereof. Recently, a display apparatus has been released on the market, which displays a picture by receiving a video signal from various external signal sources such as a video tape recorder (VTR), a video camcorder, a set top box (STB) or the like to boost practical uses thereof.

The display apparatus comprises a processor to process the video signal received into a displayable format. Particularly, the display apparatus requires at least one processor to process various video signals received from various kinds of signal sources. Generally, the processor comprises an OSD block to provide a user with a selection menu through an OSD function.

FIG. 1 is a control block diagram of a conventional display apparatus. As shown therein, the display apparatus comprises a first processor 10 and a second processor 20.

The first processor 10 comprises an OSD generator 12. The first processor 10 receives a video signal and outputs the video signal to the second processor 20 after processing it.

The video signal refers to a video signal inputted from a VTR or a digital versatile disk (DVD) player, a standard definition (SD) video signal, or a high definition (HD) video signal. According to the inputted format, such video signals pass through an analog to digital (A/D) converting process or a decoding process to be processed as a displayable signal.

When an OSD generating signal is received while the first processor 10 processes the video signal inputted thereto, the OSD generator 12 generates an OSD signal. The OSD signal generated by the OSD generator 12 is mixed with the video signal processed by the first processor 10, and the mixed signal is then inputted to the second processor 20.

When the OSD generating signal is received while the second processor 20 processes the video signal inputted thereto, an OSD generator 22 generates an OSD signal. The OSD signal generated by the OSD generator 22 is mixed with the video signal processed by the second processor 20, and is then outputted to and displayed on a display part (not shown). The video signal transmitted from the first processor 10 to the second processor 20 may be completely processed in the first processor 10 and simply passes through the second processor 20, or processed in the second processor 20 as a final displayable format. The second processor 20 may receive an inputted PC signal.

When the display apparatus comprising two or more processors receives the OSD generating signal, each of the processors processing the video signal generates an OSD signal. As the OSD signals generated by each of the processors are different from each other, there is no uniformity therebetween. Also, resolution and brightness are changed by the processor's performance, thereby displaying the OSD in different qualities.

FIG. 2 is a control block diagram of another conventional display apparatus to solve a problem of the OSD generation of the display apparatus in FIG. 1. As shown therein, a display apparatus comprises a first processor 10, a second processor 20, and an OSD processing chip 30.

The first processor 10 processes an externally inputted video signal, and outputs the processed video signal to the second processor 20. The video signal may be inputted to the second processor 20 after being processed as a final predetermined format to be displayed, or may be inputted to the second processor 20 to be scaled.

If a command to generate the OSD signal is received, the OSD processing chip 30 generates the OSD signal and outputs it to the second processor 20.

The second processor 20 mixes a PC signal inputted or the video signal outputted from the first processor 10 with the OSD signal generated from the OSD processing chip 30.

According to a control method which is set, the OSD signal generated and the video signal are mixed with each other by at least one processor. That is, the video signal and the PC signal may be mixed with the OSD signal in the processor processing each signal, or in another processor.

The display apparatus illustrated in FIG. 2 solved the problem of the display apparatus in FIG. 1. However, the display apparatus in FIG. 2 additionally employs the OSD processing chip 30 instead of employing the OSD generator comprised in the processor, thereby generating extra expenses.

### SUMMARY OF THE INVENTION

Accordingly, it is an aspect of the present invention to provide a display apparatus, which generates a uniform OSD window and reduces costs.

Additional aspects and/or advantages of the present invention will be set forth in part in the description which follows and, in part, will be obvious from the description, or may be learned by practice of the present invention.

The foregoing and/or other aspects of the present invention are achieved by providing a display apparatus comprising a first processor outputting an OSD video signal or a processed first video signal comprising an OSD window; an OSD extractor extracting the OSD window from the OSD video signal; and a second processor mixing an externally inputted second video signal and the OSD window extracted from the OSD extractor, and outputting the mixed signal.

According to an aspect of the present invention, the OSD extractor comprises a block determining position information on an area of an OSD window field from the OSD video signal outputted from the first processor, and a block extracting the OSD window from the OSD video signal by using the position information.

The foregoing and/or other aspects of the present invention are also achieved by providing a method of controlling a display apparatus comprising receiving an OSD input signal; outputting an OSD video signal comprising an OSD window from a first processor; extracting the OSD window from the OSD video signal outputted from the first processor; and mixing an externally inputted second video signal and the OSD window extracted from an OSD extractor, and outputting the mixed signal.

According to an aspect of the present invention, extracting the OSD window comprises determining position information on an area of the OSD window from the OSD video signal outputted from the first processor; and extracting the OSD window from the OSD video signal by using the position information.

### BRIEF DESCRIPTION OF THE DRAWINGS

The above and/or other aspects and advantages of the present invention will become apparent and more readily appreciated from the following description of exemplary embodiments, taken in conjunction with the accompanying drawings of which:

FIG. 1 is a control block diagram of a conventional display apparatus;

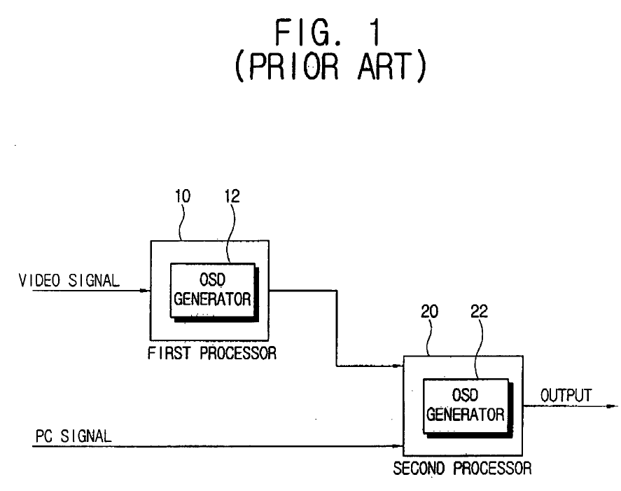

FIG. 2 is a control block diagram of another conventional display apparatus;

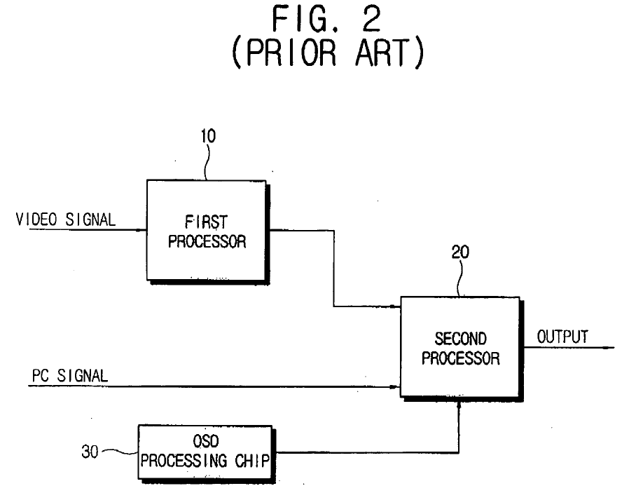

FIG. 3 is a control block diagram of an exemplary embodiment of a display apparatus according to the present invention; and

FIG. 4 is a control flow chart of the display apparatus according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The exemplary embodiments are described below in order to explain the present invention by referring to the figures.

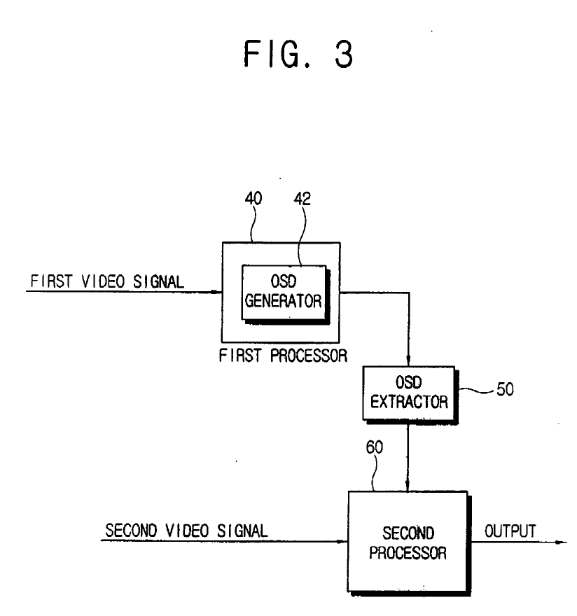

As shown in FIG. 3, a display apparatus according to an exemplary embodiment of the present invention comprises a first processor 40 and a second processor 60 to process video signals in different formats; and an OSD extractor 50.

The first processor 40 processes an externally inputted first video signal, and comprises an OSD generator 42. The first processor 40 comprises blocks for processing the first video signal such as converting an externally inputted analog signal to a digital signal, decoding the first video signal in an encoded state, adjusting the processed first video signal into a predetermined resolution and color sensation, etc., and processing the inputted first video signal into a predetermined format to be displayed.

When receiving an OSD input signal in order to generate an OSD signal while the first processor 40 processes the first video signal, the OSD generator 42 generates the OSD signal. The first processor 40 mixes the video signal processed by the first processor 40 with the OSD signal generated by the OSD generator 42, and outputs the processed first video signal comprising the OSD window. The processed first video signal outputted from the first processor 40 simply passes through the second processor 60 to form an output to be displayed. A function of video signal scaling may be realized in either the first processor 40 or the second processor 60, thus the first video signal may pass through the first processor 40 and scaling may be performed in the second processor 60.

The second processor 60 processes an externally inputted second video signal. As an exemplary embodiment of the present invention, the second video signal refers to a PC signal. The PC signal is different from the video signal received from a broadcasting station or generated from a video generating apparatus like a VTR in frequency band and resolution, thereby employing an extra processor for processing it.

When receiving the OSD input signal while the second processor 60 processes the second video signal, the OSD generator 42 of the first processor 40 generates the OSD signal. At this time, the first processor 40 outputs an OSD video signal comprising the OSD signal, and the OSD video signal is inputted to the OSD extractor 50.

The OSD extractor 50 extracts an OSD window from the OSD video signal in one frame outputted from the first processor 40. The OSD extractor 50 comprises blocks for determining position information on an area of the OSD window from the OSD video signal in one frame outputted from the first processor 40, and for extracting the OSD window from the OSD video signal by using the position information. That is, after determining the position information on the OSD window area from the OSD video signal outputted from the first processor 40, the OSD extractor 50 extracts the OSD window from the OSD video signal in one frame by using the position information. Then, the second processor 60 mixes the second video signal processed by the second processor 60 and the OSD window supplied from the OSD extractor 50, and outputs the mixed signal.

According to characteristics of the second video signal, the second processor 60 mixes the second video signal inputted and the OSD window either before or after processing the second video signal. For example, if the second video signal inputted is an analog signal, the second video signal goes through an A/D converting process before being mixed with the OSD position information as a digital signal. If the second video signal only requires a scaling to be displayed, the second video signal may be mixed with the OSD window extracted from the OSD extractor 50 to be processed into a predetermined format.

The OSD extractor 50 does not comprise an extra process element or a chip, but comprises a part of the functions of the second processor 60. As the processors are not provided with additional hardware for the OSD extractor 50, a configuration thereof is different from employing a conventional OSD processing chip 30.

An exemplary embodiment of the present invention may receive a video signal having a different format from the first and second video signals, and comprise at least one processor processing such video signals. If the OSD window is required to be generated while the additional processor processes the video signal, it is possible to extract the OSD window generated from the first processor 40 to mix with the video signal inputted.

Also, the display apparatus according to an exemplary embodiment of the present invention may comprise a controller (not shown) receiving the OSD input signal to make the first processor 40 output an OSD video signal comprising the OSD window, extracting the OSD window from the OSD video signal outputted from the OSD extractor 50, and controlling to mix the second video signal and the OSD window in the second processor 60.

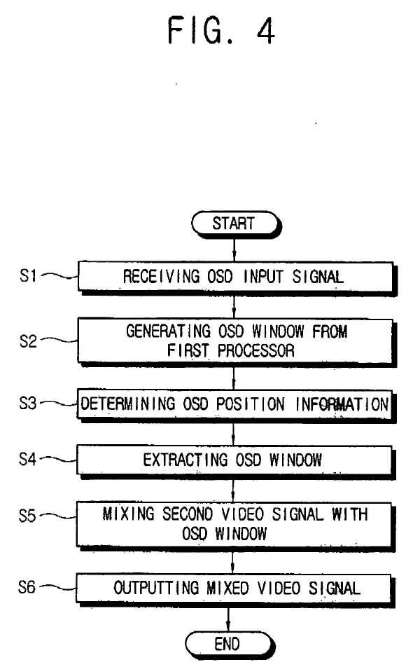

FIG. 4 is a control flow chart of the display apparatus according to an exemplary embodiment of the present invention.

When receiving the OSD input signal at operation S1, the OSD generator 42 in the first processor 40 generates the OSD signal at operation S2. The OSD window according to the OSD signal generated by the OSD generator 42 is inputted to the second processor 60. At operation S3, the OSD extractor 50 determines the position information on the OSD window area from the OSD video signal outputted from the first processor 40, and extracts the OSD window from the position information at operation S4. At operation S5, the second processor 60 mixes the externally inputted second video signal and the OSD window extracted from the OSD extractor 50, and outputs the mixed signal at operation S6.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a first processor outputting an on-screen display (OSD) video signal or a processed first video signal comprising an OSD window;
an OSD extractor extracting the OSD window from the OSD video signal; and
a second processor mixing an externally inputted second video signal and the OSD window extracted from the OSD extractor, and outputting a mixed signal.

2. The display apparatus according to claim 1, wherein the display apparatus receives an OSD input signal.

3. The display apparatus according to claim 2, further comprising a controller receiving the OSD input signal and controlling the first processor to output the OSD video signal comprising the OSD window, extracting the OSD window from the OSD video signal, and controlling a mixing of the second video signal and the OSD window in the second processor.

4. The display apparatus according to claim 1, wherein the OSD extractor comprises a block determining position information on an area of an OSD window field from the OSD video signal outputted from the first processor, and a block extracting the OSD window from the OSD video signal by using the position information.

5. A method of controlling a display apparatus comprising:
receiving an on-screen display (OSD) input signal;
outputting an OSD video signal comprising an OSD window from a first processor;
extracting the OSD window from the OSD video signal outputted from the first processor; and
mixing an externally inputted second video signal and the OSD window extracted from an OSD extractor, and outputting a mixed signal.

6. The method according to claim 5, wherein the extracting the OSD window comprises determining position information on an area of the OSD window from the OSD video signal outputted from the first processor; and extracting the OSD window from the OSD video signal by using the position information.
